(19) United States
(12) Patent Application Publication
(10) Pub. No.: US 2008/0270903 A1
(43) Pub. Date: Oct. 30, 2008

(54) SYSTEM, METHOD AND SOFTWARE FOR AN ON-LINE MEDIA PLAYER

(75) Inventors: Christopher Trahan, San Jose, CA (US); David Olszewski, San Jose, CA (US)

Correspondence Address: SCHNECK & SCHNECK, P.O. BOX 2-E, SAN JOSE, CA, 95109-0005, US

(73) Assignee: RAZDOG.COM, San Jose, CA (US)

(21) Appl. No.: 11/836,651

(22) Filed: Aug. 9, 2007

Related U.S. Application Data
(60) Provisional application No. 60/836,898, filed on Aug. 9, 2006.

(51) Int. Cl. G06F 3/048

(52) U.S. Cl. 715/716

(57) ABSTRACT

A system and method including loading a media player on a third party website. This media player allows a user to play media at the user's request, store and catalog media files, and connect to an external electronic commerce host to facilitate the purchase of media content.

### CROSS-REFERENCE TO RELATED APPLICATION

This application claims priority from U.S. provisional application No. 60/836,898, filed Aug. 9, 2006.

### TECHNICAL FIELD

The present invention relates generally to software and related systems and methods and more specifically media player software.

### BACKGROUND

There is an established and growing trend for media purchasing and use to take place in the on-line environment. Sales of online content continue to grow as additional users convert to electronic distribution of media content. For existing artist and media companies, some having existing audiences or at least content consumers having one or more impression through content exposure, have a need for building a user base and sharing in the on-line revenue stream.

A search inquiry on a global computer network found more than half a billion search results for the term “on-line music”. Despite this wide spread use of this term in resultant web pages there is a need for additional options of media players. For artists of companies designing websites, a player that cooperatively acted to aid in the sales and purchasing of on-line media content is desirable.

An improved media player has the opportunity to meet a number of user needs. The needs include:

1. Desire for a significant new revenue source that would be available around the clock to generate revenue for content providers.
2. Securing new users with cross promotion.
3. Attraction of users to spend additional time at existing websites and strengthening market bonds with current customers.
4. Simplified integration of a new tool with existing online content.
5. Allow creation and leveraging of multi-faceted merchandising programs and multi-media advertising environments.

### SUMMARY

The above needs are met with an enhanced media player. The media player may be executed through a method that is executable on a user accessible third party website. The media player is obtained through this third party website or through a host website. The method includes loading a media player on a third party website. This media player includes a component capable of playing media at a user's request. The method also includes providing as part of the media player a component able to store and catalog media files. This component may allow storing on the user's local machine, on the third party website, or on a host site. The method further includes providing as part of the media player a component able to connect to an electronic host (defined as separate from the third party website) and facilitate at the host a purchase of media content from the electronic host. Facilitate in this context means to allow a user to select purchase and have streamed or otherwise transferred to the user media content in electronic form. The cataloging and storing of media files may be done by accessing media files in a host database which is separate from the third party website.

The present method may include providing a number of additional features. This may include providing a security log in requirement that requires a user to enter a security password before initiating an action on the media player. Another feature may be providing a content converter in which user provided content can be converted into a standard host format. Another feature may be providing as part of a media player a media search tool. This media search tool may be configured to search host database. Another feature which could be provided as part of said media player is a tool allowing reading or loading for media content. Another feature of the media player that could be provided as part of the media player is a media playlist generated by input of the user, the third party website, or the host. Another feature that may be provided as part of the media player is an advertisement display which may include content provided by the third party website. Another feature provided as part of the media player is a tool for presetting spending limits for purchases. This provided presetting of spending limits may include tool allowing prepaying for media content. Another possible feature provided as part of the media player is a tool for limiting access to content based on content rating.

### BRIEF DESCRIPTION OF THE DRAWINGS

FIG. 1 is a schematic of a media player embodiment as used with a third party site and a network.

FIG. 2 is an operation chart of a media player embodiment as used with a third party website and a network.

FIGS. 3a and 3b are a screen shots of a media player on a website.

FIGS. 4a, 4b, and 4c are partial screen shots of just the interface for the media player.

### DETAILED DESCRIPTION

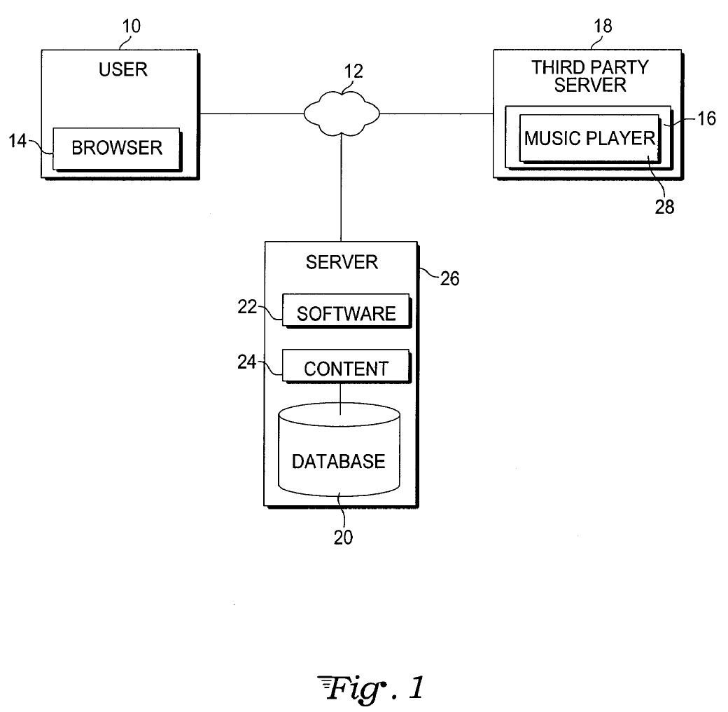

In one embodiment, in FIG. 1 a user's computer 10 is connected to a network 12 and is running a network browser 14 such as NETSCAPE NAVIGATOR, MICROSOFT Internet Explorer, MOZILLA FIREFOX, etc. The user accesses a third party website whose content 16 is stored at a server 18 which is connected to a network. When the third party website is accessed, for instance by the user identifying the requested website using a uniform resource locator (“URL”) associated with the website, and the browser requesting the content associated with the website using an http request, the media player 28, which is incorporated into the third party website, is returned to the user's computer along with the other requested content 16. The user may use any of the media player's features without having to leave the third party's website, which means, for instance, that the user may play different types of media and operate the media player, while browsing the third party website's content. In other embodiments, the media player 28 may be accessed by the user's cell phone, PDA, or any other Internet-enabled device.
The media player allows a user access to various types of content. The media player may play different types of media and allows users to use various different features at a remote site without having to access a dedicated site to either use the media or feature. The different media types that the media player may play include, but are not limited to, music, and video, including but not limited to music videos, movies, and television programming. The other features that may be accessed by the media player and accessed by the user include, but are not limited to, ringtones, e-mail chat, blogs, etc. Advertising may also be presented to the user via the media player.

In one embodiment, the user accesses media player features by entering some identifier associated with the user. For instance, the user may enter an e-mail address that a database associated with the media player associates with the user. (Other identifiers, including, but not limited to, passwords may be used in other embodiments.) In FIG. 1, the database 20, and operating software 22 and content 24 (such as music files), associated with the media player are located on a server 26 connected to a network 12. In other embodiments, the database 20, software 22, and content 24 may be running on any combination of devices connected to a network 12. If the user has personalized content (for instance, playlists), the contents of the playlist are streamed to the media player. The user may also access other features of the media player, such as searching for music, videos, ringtones, etc., or purchasing music, videos, ringtones, etc.; the database will search for the user's choices and return the requested information. The media player also has features for completing the user's purchase. Other features, such as a pre-authorized spending account, may be implemented. The media player 28 may request, and be provided with, content from the remotely-located elements (database 20, software 22, and content 24 (of the media player system using SOAP web services or http requests.

In one embodiment, the media player is implemented using software. The software may be provided as a computer program product which may include a computer-readable medium having stored thereon instructions which, when read, cause a computer (or other electronic devices) to perform a process or method. The computer-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/computer-readable computer readable medium suitable for storing electronic instructions. Moreover, the event management may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as a comprising a computer-readable medium.

In other embodiments, the media player may be “free standing,” i.e., accessed as a separate program (for instance, a computer desktop application).

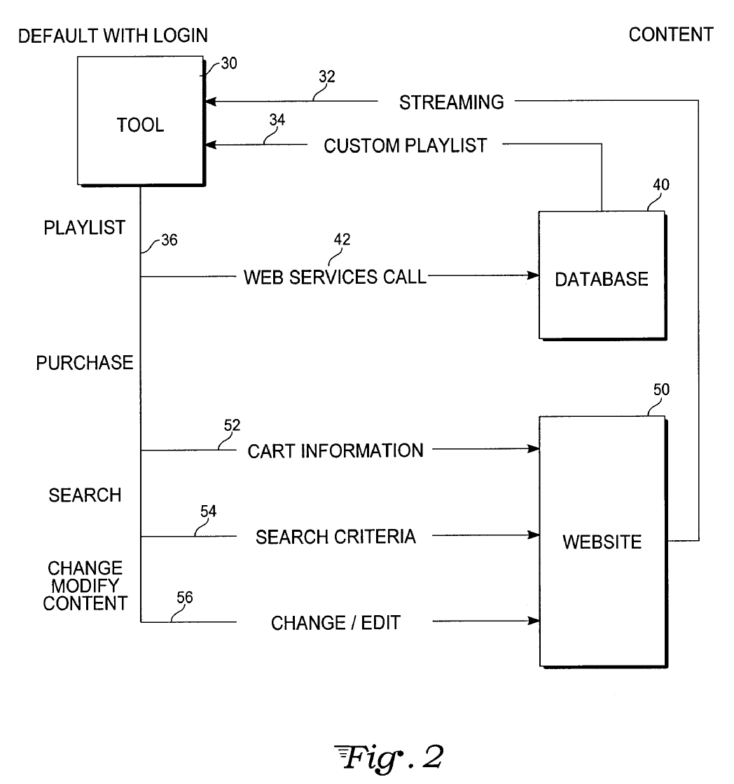

With respect to FIG. 2, an operational chart showing the media player tool 30 is shown. The media player 30 may be a stand alone program loaded onto a local system, be integrated into an operating system web browser or other software program, or may be an applet such as an HTML tool integrated as a portion of a website. The tool may send commands and data via up line 36 to both a database 40 and a website 50 may, for example, be a specific location on a global computer network. A playlist quarry sent on output 36 would be channeled via route 42 to database 40. A custom playlist generated from database 40 would be driven by connection 34 back to media player tool 30. Output 36 may also send purchase information sent via connection 52 to website 50, search quarries sent via connection 54 or an instruction to change or modify content saying sent via connection 56 to website 50. The resultant data which may be purchased media files, search results possibly including small sample files of search results produced from search criteria, or a site change/edit such as a addition of funds to a charge account would be streamed via website input and tool input connection 32 to media player tool 30.

In one embodiment, all communication is via SOAP web services or standard http requests.

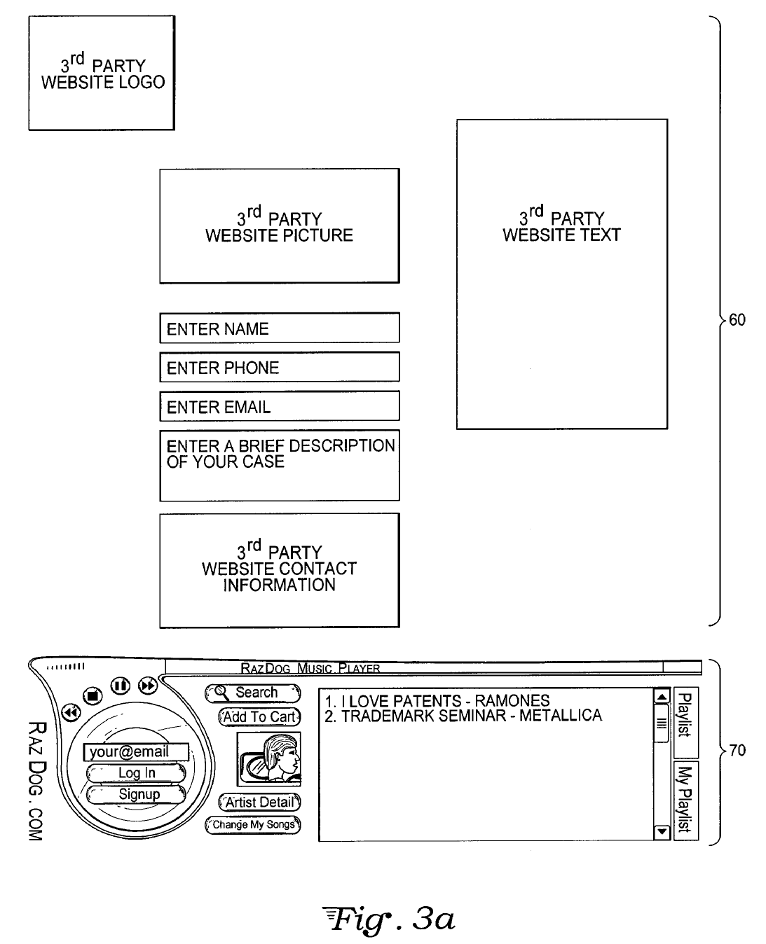

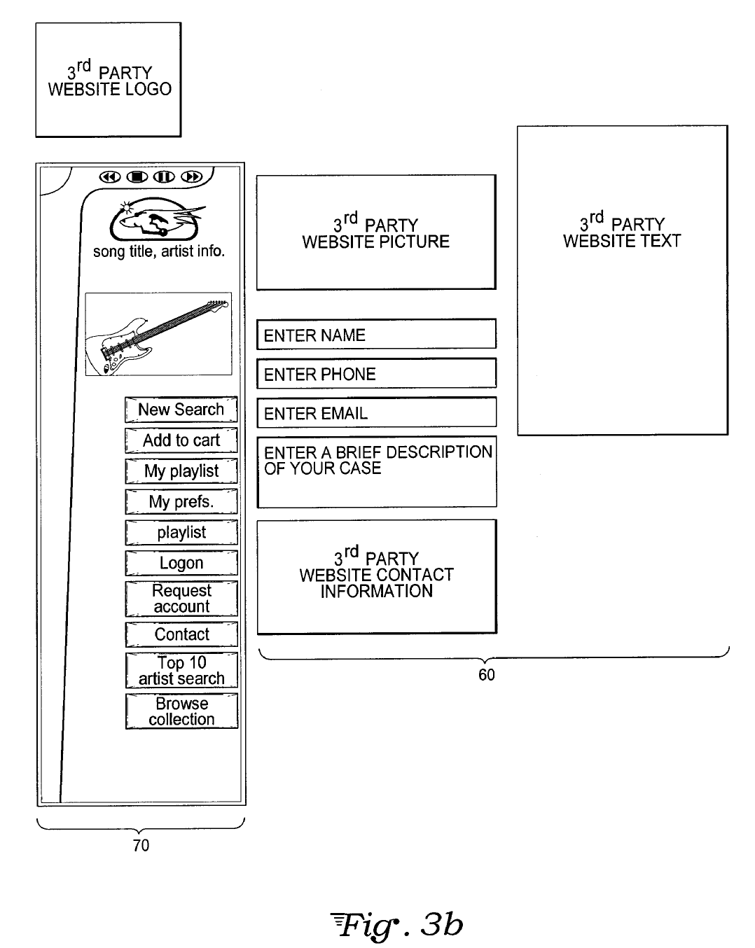

With reference to FIG. 3, a screen shot is shown with a RazDog™ media player interface 70 shown on a third party website 60. In FIG. 3a, interface 70 is a bar at the bottom of a page, in FIG. 3b, interface 70 extends along one side of the page.

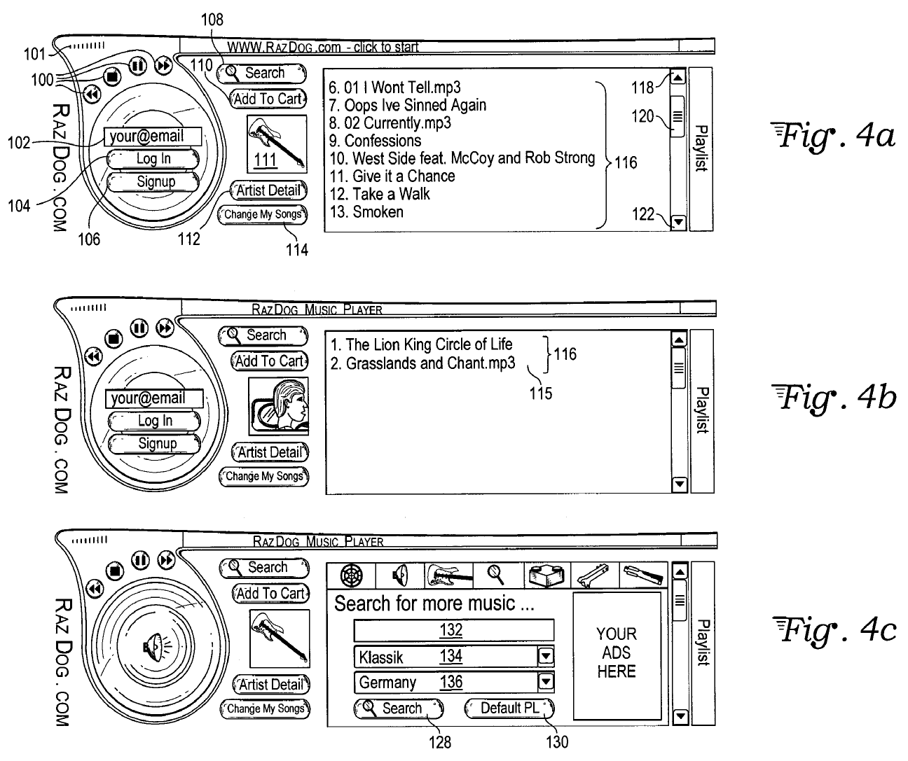

FIG. 4a shows just the media player interface of FIG. 3a. This interface in this embodiment includes a volume control/indicator 101, and media control buttons 100 to allow the media player to stop, play, reverse or fast forward through the media. A login box 102 allows a user to sign in to the system. A password, such as an email address is entered into box 102 and then the user activates button 104, such as with a mouse click. The user would then be logged on and could access user specific content, such as playlists and a personal media file directory. The signup button 106 allows new users to sign up and create an account for the purchase of media content, generation of personalized playlists, etc.

Search button 108 activates a search feature shown in FIG. 4c. On this screen a user can activate box 132 (as with a mouse click), type in or otherwise enter one or more search terms in the box, and then activate button 140 to send the search request, as shown in FIG. 2. The user can also use drop down menus 134, 136, for selection of media language, media classes, or other category selection. A separate button 130 allows selection of a default playlist. In this view of the interface, part of the interface is an advertisement display 140, that could advertise products or services from the third party host of the media player.

Returning to FIG. 4a, both this shot of the interface and the views of the interface shown in FIGS. 4a, 4b and 4c, all show an “Add To Cart” button 110, which would send a signal to place a highlighted or otherwise selected media file in the purchase queue. The media file would then be streamed from the host website upon authentication of payment. These three views of the interface also have an “Artist Detail” button 112, which allows request for streamed or embedded artist information. Related media art may be displayed in box 111. Finally, these three views all show a “Change my Songs” button 114, which allows selection of alternative playlists, a shuffle feature, or other similar feature.

A partial list of a playlist 116 is shown in FIG. 4a, and a complete playlist 117 is shown in FIG. 4b. In FIG. 4b one of the songs on the list is highlighted area 115. In FIG. 4a, the user could move up or down the playlist using arrow buttons 118, 122 or by moving slider button 120.

The present embodiments relate to a global computer network (e.g. internet) software technology which enables users remote login (to the host site), purchase, download, stream, search, events, and create a personalized environment and non personalized media content (advertising, merchandise, etc.) for their music, video, television, merchandise and advertising, including in some embodiments the setup of personalized spending accounts. This software ties into a host site and host database infrastructure which enables users to setup and pull their personal data and any host content from the host site or server. This software technology will be provided (licensed) to online websites (specifically, media companies, including TV, radio, newspapers and other websites around the world. This allows them to very easily integrate the software and use the host content. The software can also be licensed to consumers for download on their personal computer and any other internet enabled device. Users can also download the software from the host site or from CDs and use it from their personal computers, cellular phones, PDAs or any internet enabled devices.

A number of present media sites allow unlimited downloading, and automatically bill for any downloaded media to a credit card. This may result in a number of unintended problems. An individual may not realize how much they are using a service and be surprised by a bill at the end of a month. A parent may also give a child a credit card and lose control of the amount of purchases made by the child. In one embodiment, these issues may be addressed by either or a combination of two features.

First, the use of the media player may be password protected. This would allow better account access protection. Second, the media player may have a preauthorized spending account to budget the amount of spending (for example, a limited total budget, a limited monthly budget, etc.) A detailed accounting could then be made over a specified time period. Consumers could have the choice of whether to use this feature.

The media player embodiments may include the following features:

1. allowing free streaming media on a third party website.
2. allowing user or third party website master customization options.
3. allowing user or third party website master a personal playlist options. This may consist of media files selected by a user, media files selected by a third party website master, media filed selected by a network community, or any combination of this or other media selection modality. The media player can be preloaded with a default playlist, for example a “top 25” media files, or media files of a selected type.
4. allowing simplified integration into an on-line environment of a global computer network.
5. allowing edits, changes, updates and searches to the media player to be made remotely and executed automatically.
6. providing an e-mail log in.
7. automatic uploading of media playlists with each log in.
8. search functions, including searching arties in a local community was well as by genre, title and artist.
9. tailored ads.
10. allow host, third party website master, or other third party to place ads, and select ads based on user, search requests, preset options, or other ad modality.
11. the third party master or the artist may set the price for downloads.

In one embodiment, a media player is presented on a third party's website. The media player's user may use the player's multiple features, including but not limited to, playing music, searching for music, purchasing music, etc. The media player may be operated (i.e., play music, play videos, search for other music, purchase music, etc.) without exiting the third party website (in other words, while the media player is operated, the third party website content is still visible).

What is claimed is:

1. A computer executed method that is executable on a user accessible third party website, comprising:
a) loading a media player on said website, said media player including a component capable of playing media at a user's request;
b) providing as part of said media player a component able to store and catalog media files; and
c) providing as part of said media player a component able to connect to an electronic commerce host and facilitate a purchase of media content from said electronic commerce host.

2. The method of claim 1, wherein step (b) includes accessing media files in a host database that is separate from said third party website.

3. The method of claim 1, further including a step of providing a security login requirement such that a user must enter a security password before initiating an action on said media player.

4. The method of claim 1, further comprising providing access through said media player of streaming purchased content to a user.

5. The method of claim 4, wherein said purchased content is selected from a group consisting of audio files, video files, ringtone files, e-mail files, chat files, and blog files.

6. The method of claim 1, wherein step (c) includes completing a checkout transaction at said electronic commerce host.

7. The method of claim 1, further including providing as part of said media player a content converter in which user provided content can be converted into an host standard format.

8. The method of claim 1, further providing as part of said media player a media search tool.

9. The method of claim 8, wherein said media search tool is configured to search a host database.

10. The method of claim 1, further providing as part of said media player a tool allowing rating or voting for media content.

11. The method of claim 1, further including providing as part of said media player a media playlist generated by input from at least one of said user, said third party website and said host.

12. The method of claim 1, further including providing as part of said media player an advertising display.

13. The method of claim 12, wherein content of said advertising display is provided by said third party website.

14. The method of claim 1, wherein providing as part of said media player a component able to connect to an electronic commerce host and facilitate a purchase of media content from said electronic commerce host includes providing a tool for presetting spending limits.

15. The method of claim 14, wherein providing a tool for presetting spending limits includes providing a tool allowing prepaying for media content.

16. The method of claim 1, further including providing a tool for limiting access to content based on content rating.

17. A method comprising:
a) associating a media player with a third party's website;
b) presenting the media player on the third party website such that a user that access said third party website will have access to said media player;
c) allowing a user of the third party website to request and access personalized content and a media electronic commerce host through the media player; and
d) operating the media player without leaving the third party website.
